(19) United States
(12) Patent Application Publication
(10) Pub. No.: US 2015/0123475 A1
(43) Pub. Date: May 7, 2015

(54) Control of Operating Equipment by Influencing a Grid Voltage

(71) Applicant: SMA Solar Technology AG, Niestetal (DE)

(72) Inventors: Daniel Premm, Kaufungen (DE); Claus Allert, Kaufungen (DE)

(21) Appl. No.: 14/595,325

(22) Filed: Jan. 13, 2015

Related U.S. Application Data
(63) Continuation of application No. PCT/EP2013/065172, filed on Jul. 18, 2013.

(30) Foreign Application Priority Data
Jul. 18, 2012 (DE) 10 2012 106 466.0

(51) Int. Cl. H02J 3/46

(52) U.S. Cl. CPC H02J 3/46
USPC 307/24

(57) ABSTRACT

To stabilize the grid voltage in a grid section which is connected to a higher-level grid via an apparatus having a variable voltage transformation ratio and which includes at least one energy consumption or generation unit, the voltage transformation ratio is changed in order to change a grid voltage level in the grid section. In at least in one mode of the method the grid voltage level is raised in order to counteract a rise in the grid voltage at the energy consumption or generation unit, or the grid voltage level is lowered in order to counteract a drop in the grid voltage at the energy consumption or generation unit. This is effectively possible since the power consumption or output of each energy consumption or generation unit in the grid section is controlled via a characteristic curve of the grid voltage present there.

### CROSS REFERENCE TO RELATED APPLICATIONS

This application is a continuation of International Application number PCT/EP2013/065172 filed on Jul. 18, 2013, which claims priority to German Application number 10 2012 106 466.0 filed on Jul. 18, 2012.

### FIELD

The present disclosure relates to a method of stabilizing the grid voltage in a grid section which is connected to a higher-level grid via an apparatus having a variable voltage transformation ratio. In addition, the present disclosure relates to an apparatus for carrying out such a method.

### BACKGROUND

It is known to design transformers such as local grid transformers which are used for linking between different grid levels, for example, between a medium-voltage and low-voltage grid, to have a variable voltage transformation ratio. This variability of the voltage transformation ratio is used to raise or lower the grid voltage level within the subordinate voltage level, if a local drop or rise in the grid voltage in the subordinate grid section otherwise falls out of an allowable range defined by grid voltage limits. This may occur, for example, if, at the end of a branch of the grid section, a heavy load results in a voltage drop and an undershooting of a lower grid voltage limit value is imminent, or a high level of fed-in power could result in an overshooting of an upper grid voltage limit value.

For example, it is known from EP 1 906 505 A1 to control energy generation units which are connected to a power supply grid with respect to their provision of electric power via a characteristic curve which is a function of the grid voltage at the respective energy generation unit.

From the field of stand-alone grids, for example, from US 2011 0043160 A1, it is known to carry out a targeted modification of the grid parameters of grid frequency and/or grid voltage via grid-forming operating equipment in order to cause the energy consumption or generation units connected to the stand-alone grid to change their power consumption or output. Furthermore, it is known to predefine a maximum value for the power consumption or output for energy consumption or generation units via a signal transmitted externally directly to the respective unit. The signal may be modulated as a ripple-control signal to the respective grid to which the energy consumption or generation units are connected.

Alternatively, another transmission medium may be provided for the signal to the energy consumption or generation units. In any case, for example, as described in DE 20 2009 018 108 U1, a reception device at the respective energy consumption or generation unit and an interface for controlling the respective unit must be provided in order to be able to receive and transform these ripple-control signals.

From EP 2 084 801 A1, a method for the controlled retrieval of electric energy from a low-voltage grid is known, in which electric energy is fed into the low-voltage grid from a decentralized current generation system and the power control of the feed-in is carried out via active variation of the grid voltage in the low-voltage grid. The variation of the grid voltage is carried out within a tolerance band of the standard voltages using operating equipment for voltage control, in particular a transformer having a variable transformation ratio, the decentralized current generation system raising its active power feed-in in the event of falling grid voltage and lowering it in the event of rising grid voltage. As a result, it is possible to homogenize the energy flow via the transformer supplying the low-voltage grid, the dynamic adjustment of the energy flow being carried out via the transformer, as required among other things for supplying control power, by varying the grid voltage on the low-voltage side of the transformer.

There still is a need of a method for stabilizing the grid voltage in a grid section which in particular counteracts the spread of the local grid voltages in the grid section as a result of the power consumption or output of decentralized energy consumption or generation units in the grid section.

### SUMMARY

The present disclosure provides a method of stabilizing the grid voltage in a grid section connected to a higher-level grid via an apparatus having a variable voltage transformation ratio. The grid section includes at least one energy consumption or generation unit whose power consumption or output is controlled via a characteristic curve of the grid voltage present there. The characteristic curve raises the power consumption of the energy consumption or generation unit with rising grid voltage or lowers the power output of the energy consumption or generation unit with rising grid voltage. The method comprises changing the voltage transformation ratio in order to change a grid voltage level in the grid section, which, in at least one mode of the method, includes at least one of (i) raising the grid voltage level in order to counteract a rise in the grid voltage at the energy consumption or generation unit, and (ii) lowering the grid voltage level in order to counteract a drop in the grid voltage at the energy consumption or generation unit.

The disclosure further relates to an apparatus having a variable voltage transformation ratio for connecting a grid section to a higher-level grid. The apparatus comprises a controller configured to set the voltage transformation ratio in order to set a grid voltage level in the grid section. The controller, in at least one operating mode, is configured to at least one of (i) raise the grid voltage level in order to counteract a rise in the grid voltage at the energy consumption or generation unit, and (ii) lower the grid voltage level in order to counteract a drop in the grid voltage at the energy consumption or generation unit.

Other features and advantages of the present disclosure will become apparent to one with skill in the art upon examination of the following drawings and the detailed description. It is intended that all such additional features and advantages be included herein within the scope of the present disclosure, as defined by the claims.

### BRIEF DESCRIPTION OF THE DRAWINGS

The present disclosure can be better understood with reference to the following drawings. The components in the drawings are not necessarily to scale, emphasis instead being placed upon clearly illustrating the principles of the present disclosure. In the drawings, like reference numerals designate corresponding parts throughout the several views.

FIG. 1 shows a schematic representation of a grid section connected to a higher-level grid via a local grid transformer.

FIG. 2 shows an example change ΔU_{NS} in a grid voltage provided by the local grid transformer according to FIG. 1 on its grid section side as a function of an active power P_{MS} obtained from the higher-level grid via the local grid transformer; and

FIG. 3 shows an example characteristic curve for the change in the active power ΔP of an energy consumption or generation unit as a function of the grid voltage present at its grid connection.

### DETAILED DESCRIPTION

The present disclosure relates to a method for stabilizing the grid voltage in a grid section which is connected to a higher-level grid via an apparatus having a variable voltage transformation ratio, wherein the voltage transformation ratio is changed in order to change a grid voltage level in the grid section. In particular, at least one energy consumption or generation unit may be provided in the grid section, whose energy consumption or output is controlled via a characteristic curve as a function of the grid voltage present there, wherein the characteristic curve raises the power consumption of the energy consumption or generation unit with rising grid voltage or lowers the power output of the energy consumption or generation unit with rising grid voltage. In addition, the present disclosure relates to such an apparatus for carrying out the method.

In particular, this apparatus may be a local grid transformer which steps a medium voltage down to a low voltage which specifies a grid voltage level in the low voltage grid section. However, the apparatus may also be a so-called linear regulator, which is used to stabilize the grid voltage level in a branch of a grid section without stepping down a higher input voltage.

The grid voltage level in a grid section is not a constant grid voltage, since the grid voltage across the grid section drops as a result of an energy consumption of energy consumption units or rises as a result of an energy output of energy generation units. The grid voltage level may be detected by measuring the grid voltage in the grid section at a point near the apparatus having a variable voltage transformation ratio. Directly at the output of the apparatus on the grid section side, the instantaneous energy consumption of the energy consumption units and the energy output of the energy generation units have the smallest effect on the grid voltage level in the grid section as compared to its specification by the voltage transformation ratio of the apparatus.

Energy consumption or generation units are also to be understood to encompass energy storage units which temporarily consume energy like an energy consumption unit in order to charge an energy store, and output this energy at other times like an energy generation unit while the store is discharging. In addition, the term energy consumption or generation units also includes grid subsections having multiple energy consumption or generation units which are connected to the respective branch of the grid section under consideration via a common connection. In particular, this includes all energy consumption or generation units in and on a building which are connected via a common building connection to a branch of a grid section, or multiple energy generation units of an energy generation system which are connected to a branch of a grid section via a common grid connection.

In a method according to the present disclosure for stabilizing the grid voltage in a grid section which is connected to a higher-level grid via an apparatus having a variable voltage transformation ratio and which includes at least one energy consumption or generation unit, the voltage transformation ratio is changed in order to change a grid voltage level in the grid section. In at least one mode of the method, the grid voltage level is raised in order to counteract a rise in the grid voltage at the energy consumption or generation unit, and/or the grid voltage level is lowered in order to counteract a drop in the grid voltage at the energy consumption or generation unit. This is effectively possible since the power consumption and/or output of each energy consumption or generation unit in the grid section is controlled via a characteristic curve as a function of the grid voltage present there, which raises the power consumption of the energy consumption or generation unit with rising grid voltage or lowers the power output of the energy consumption or generation unit with rising grid voltage. As a result of this characteristic curve profile, each controlled energy consumption or generation unit tends to lower the spread of the grid voltage in the grid section as a response to the change of the grid voltage level according to the present disclosure, because a higher grid voltage triggers a higher power consumption and a lower power output, and vice-versa.

In the method according to the present disclosure, the individual energy consumption or generation units are controlled locally via characteristic curves which are functions of the grid voltage. However, the grid voltage level in the grid section is changed in a targeted manner via an apparatus whose variable voltage transformation ratio has been previously used only to keep the grid voltage in the grid section which is subordinate to it within predefined limits. This is done in order to utilize the characteristic curve control of the energy consumption or generation units in the grid section for a modulation of their power consumption or output and thus to have a reductive influence on the spread of the local grid voltages. For this purpose, the grid voltage level in the mode of the method according to the present disclosure is changed in an seemingly incorrect direction, i.e., further upward in the case of local grid voltages which are too high and further downward in the case of local grid voltages which are too low.

During the normal operation of an apparatus having a variable voltage transformation ratio, via which a grid section is connected to a higher-level grid, the voltage transformation ratio would be changed in the event of the grid voltage approaching an upper or lower grid voltage limit value at any monitored point, for inversely lowering or raising the grid voltage level in the grid section. An attempt would be made to lower or raise the grid voltage in the entire grid section to the extent that it maintains the predefined grid voltage limits throughout. However, the method according to the present disclosure takes into consideration the typical cause of a grid voltage at an individual energy consumption or generation unit which deviates from the grid voltage at the output of the apparatus on the grid section side approaching the upper or lower grid voltage limit value, i.e., a high level of active power consumption or output which is not compensated for by local power output or power consumption of other energy generation or consumption units. If, in such a situation, according to the present disclosure, a grid voltage which has already fallen is lowered even further by reducing the grid voltage level, this results in the local power consumption of energy consumption units being lowered and the local power output of energy generation units being increased, thus causally counteracting the drop in the grid voltage. In other words, by lowering the voltage level in the grid section, it is possible to reduce a local imbalance between the power consumption which is too high and power output which is too low, thereby reducing the spread of the grid voltage in the grid section overall and thus making it easier to keep the grid voltage in the overall grid section within the grid voltage limits. Conversely, if the local power output is greater than the local power consumption and the grid voltage correspondingly rises locally in the grid section, by further raising the grid voltage according to the present disclosure with the aid of the voltage transformation ratio of the apparatus, the local power output may be impeded and thus reduced, while the local power consumption is eased and thus increased. In this way, the local excessive voltage rise is also causally counteracted. On the other hand, the conventional approach of lowering the grid voltage level in the event of a local excessive voltage rise may result in the local power output being increased even further and the local power drop being reduced even further, as a result of which the power disequilibrium and thus the spread of the grid voltage in the grid section increases further. Such a large spread of the grid voltage generally makes it difficult to keep the grid voltage in the entire grid section within the predefined grid voltage limits.

Thus, the basic function of the apparatus having the variable voltage transformation ratio, i.e., of keeping the grid voltage in the lower-level grid section within predefined grid voltage limits, is actually not lost in this method. Instead, in the method according to the present disclosure, another means of achieving the hitherto sought function is merely adopted.

Basically, in the method according to the present disclosure, the characteristic curve of an energy generation unit may control its provision of reactive power, because it is also possible to influence the local grid voltage in the grid section in this way. However, in one embodiment, the characteristic curves of the controlled energy consumption or generation units control their active power consumption and/or output.

In particular, the characteristic curves may have a dead band in which there is no response to changes of the grid voltage present at the respective energy consumption or generation unit, and which is adjoined by slopes on both sides. In the method according to the present disclosure, these slopes lie directly within a tolerance band of the grid voltage, in order to be able to use them within this tolerance band for stabilizing the grid voltage in the grid section according to the present disclosure.

The ideal profile of the characteristic curve of an energy consumption or generation unit situated at a particular point of the grid section is in particular depending on the given grid impedance at this location, i.e., the electrical distance of this location from the apparatus having the variable voltage transformation ratio. Ideally, the characteristic curve of the respective energy consumption or generation unit is therefore determined depending on its location and in particular depending on the given grid impedance at the location. This determination may be carried out once or also dynamically depending on instantaneous values of the grid impedance.

The method according to the present disclosure may be activated if an active power flow through the apparatus exceeds an active power limit value. In other words, until this active power limit value is exceeded, the voltage transformation ratio of the apparatus may be changed according to a conventional algorithm, in which a rise in the grid voltage is counteracted by a reduction of the grid voltage level and vice-versa. A higher active power flow through the apparatus is an indication that more electric power is consumed than generated or more electric power is generated than consumed in the grid section. Both are conditions under which the spread of the grid voltage in the grid section tends to increase. This spread is counteracted by the mode of the method according to the present disclosure.

In order to monitor the active power flow through the apparatus for the overshooting of an active power limit value, it is not mandatory for the active power flow through the apparatus actually to be measured at the apparatus by, for example, measuring a current and the associated voltage there. Often, for the method according to the present disclosure, it is sufficient if it is merely somehow possible to monitor the active power flow through the apparatus for the overshooting of an active power limit value. It is also not necessary for this to be a limit value for the instantaneous active power. Rather, for example, the maintenance of an average active power limit value may also be monitored via a temperature measurement at the apparatus, since a higher transmitted active power is normally associated with a correspondingly higher power dissipation and subsequently with a temperature increase.

If the active power flow through the apparatus is measured at the apparatus, the change of the voltage transformation ratio may be matched to the characteristic curves of the individual energy consumption or generation units in the grid section in such a way that, in addition to stabilizing the grid voltage, the active power flow through the apparatus is kept within predefined active power flow limits. For example, the goal may be pursued of keeping the active power flow as small as possible via the apparatus in order to load the higher-level grid as little as possible due to the total power consumption and power output of the grid section. For this purpose, in the event of increasing active power which flows from the grid section into the higher-level grid, the grid voltage level may be raised by changing the voltage transformation ratio to such an extent that the energy generation units output less power and the energy consumption units in the grid section consume more power. As a result, the active power flow in the specified direction is effectively reduced. The exact matching between the change of the voltage transformation ratio and the characteristic curves may be carried out in the sense of a control system, based on a knowledge of the characteristic curves. Conversely, the voltage transformation ratio may be changed in the sense of a regulating system until the desired influence on the active power flow is set even in the case of initially unknown characteristic curves. Intermediate forms are also possible, it also being possible, alternatively to the direct influence in the sense of a functional relationship between voltage and output or consumed active power of the energy generation or consumption units, for the characteristic curves to be designed to act indirectly, in particular in the case of a regulating structure. For example, based on the characteristic curves, remuneration or reference rates for output or input active power may be functions of the grid voltage, so that in the event of an influence of the grid voltage in the grid section, the energy generation or consumption units modify their output or input active power in order to achieve an economical optimum.

In one embodiment of the method according to the present disclosure in an operational mode, the voltage transformation ratio may be changed as a function of the active power flow through the apparatus and the instantaneous grid voltage level on the grid section side of the apparatus. The instantaneous grid voltage level may be measured in the form of a grid voltage at a point near the apparatus on its grid section side. In this way, the necessity of communicating the local grid voltages at the location of the apparatus having the variable voltage transformation ratio is eliminated. However, only certain conclusions may be drawn about the spread of the local grid voltage from the active power flow through the apparatus and the instantaneous value of the grid voltage level. Therefore, in one embodiment, the voltage transformation ratio is changed in the mode of the method according to the present disclosure as a function (e.g., a direct function) of the grid voltage measured at the energy consumption or generation units.

As already initially indicated, the apparatus having the variable voltage transformation ratio may in particular be a controllable local grid transformer or a so-called linear regulator. In the case of a linear regulator, conclusions about the spread of the local grid voltages in the lower-level grid section may be drawn from the absolute voltage at its location. A high voltage indicates a power flow to the higher-level grid and thus raised local grid voltages in the lower-level grid section. A low voltage indicates an active power flow into the lower-level grid section and lowered local grid voltages there.

The method according to the present disclosure may also be carried out in a cascaded manner for the entire grid section, for example, with the aid of a local grid transformer, and in addition, particularly for a grid subsection of this grid section, for example with the aid of a linear regulator. In such an embodiment there is no negative overlapping of the effects in the individual cascade stages. Rather, a mutually reinforcing overlapping occurs at most.

In an apparatus having a variable voltage transformation ratio for connecting a grid section to a higher-level grid, wherein the apparatus is provided for carrying out the method of this disclosure and comprises a controller which sets the voltage transformation ratio in order to set a grid voltage level in the grid section, the controller, in at least one operating mode, raises the grid voltage level in order to counteract a rise in the grid voltage at the energy consumption or generation unit, and/or lowers the grid voltage level in order to counteract a drop in the grid voltage at the energy consumption or generation unit.

The apparatus according to the present disclosure may comprise devices for detecting the active power flow through the apparatus to monitor the active power flow through the apparatus for the overshooting of an active power limit value, wherein its controller transitions into the mode of the method if an active power flow is above the active power limit value. The detection of the active power flow may be limited to the devices monitoring whether the active power flow through the apparatus exceeds the active power limit value. However, the devices may also measure the active power flow directly at the apparatus.

Furthermore, devices may be provided which detect the grid voltage level on the grid section side of the apparatus by measuring a grid voltage at a point near the apparatus on its grid section side. In particular, this point is at the output of the apparatus on the grid section side. However, such devices are in any case frequently present in apparatuses having a variable voltage transformation ratio for connecting a grid section to a higher-level grid.

For the inverse reaction of the voltage transformation ratio to local drops or excessive rises of the grid voltage, in particular in the case of a large active power flow through the apparatus with respect to the usual one, the controller of the apparatus may include inputs for local grid voltages measured at individual energy consumption or generation units or other points in the grid section. Alternatively or additionally, the controller of the apparatus may include inputs for data derived from the measured local grid voltages, for example, messages for leaving voltage limits and/or for specifications for the voltage transformation ratio.

The apparatus according to the present disclosure is in particular a local grid transformer or a so-called linear regulator.

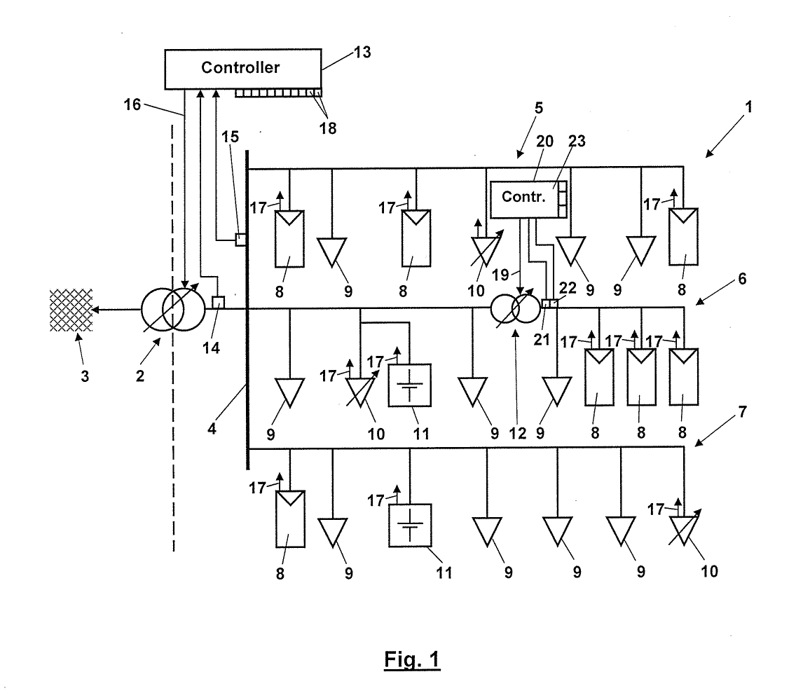

Now referring in greater detail to the drawings, a grid section 1 schematically represented in FIG. 1 is connected to a higher-level grid 3 via a local grid transformer 2. The local grid transformer 2 has a variable voltage transformation ratio between the higher-level grid 3 and a grid voltage at a busbar 4 which specifies a grid voltage level in the grid section 1. Various branches 5 through 7 of the grid section 1 branch off from the busbar 4. Various energy consumption or generation units 8 through 11 are connected to each of the branches 5 through 7. The energy generation units 8 are depicted here by way of example as photovoltaic systems including inverters and photovoltaic generators; alternatively or additionally, the energy generation units 8 may also use other regenerative energy sources such as wind or may be designed as conventional power plants, in particular as combined heat and power plants. The energy consumption units 9 are general loads. The energy consumption units 10 are loads having power consumption controlled via a characteristic curve. The energy storage units 11 include a battery which is connected to the respective branch via a battery inverter. Furthermore, a so-called linear regulator 12 is provided in the branch 6, which is able to bring about a voltage step in order to keep the grid voltage in the part of the branch 6 which is remote from the grid 3 at a desired voltage level. Via the local grid transformer 2, it is possible to set the grid voltage on the busbar 4 within certain limits, which are also referred to as the tolerance band. This is commonly done for the purpose of shifting the grid voltage with a given spread in the grid section 1 in such a way that it remains within predefined grid voltage limits throughout the grid section 1, i.e., even where it is shifted further away from the busbar 4 due to high local power input and/or output with respect to the grid voltage on the busbar 4.

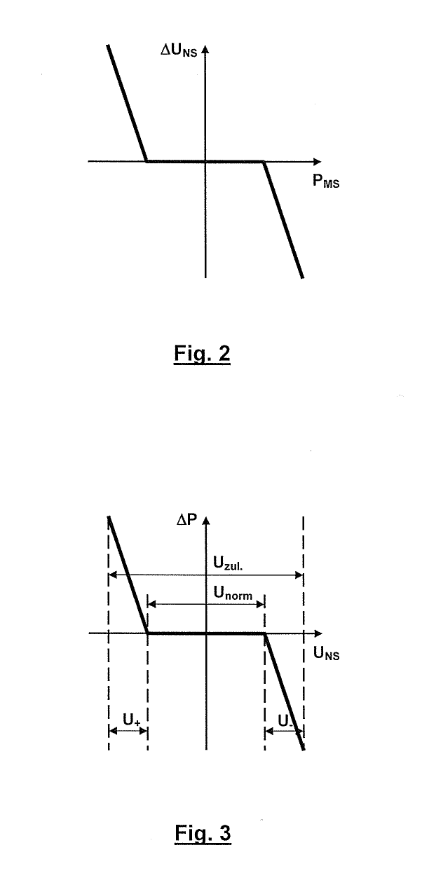

In one specific embodiment of the method according to the present disclosure, a power flow through the local grid transformer 2 according to FIG. 1 is measured and an instantaneous value of the grid voltage on the busbar 4 are measured and signaled to a controller 13 by measuring devices 14 and 15, respectively. Based on this, the grid voltage on the busbar 4 is shifted by the controller 13, via a control command 16, changing the transformation ratio of the local grid transformer 2 by a value ΔU_{NS}, as illustrated in FIG. 2. Here, the depicted direction of P_{MS} corresponds to an active power flow from the grid 3 into the grid section 1 according to FIG. 1. Correspondingly, negative values of P_{MS} represent an active power flow, i.e., a feed into the grid 3. In the case of high active power flow into the grid section 1, the grid voltage on the busbar 4 and thus the grid voltage level in the grid section 1 are lowered. However, in the case of high active power flow out of the grid section 1, they are raised. As a result of this, the active power flow is leveled, because a lower grid voltage level tends to lead to a lower power consumption and a higher power output of the corresponding energy consumption and generation units in the grid section 1, and vice-versa. In addition, the active power flow may thus be minimized from an absolute point of view in order to load the grid 3 via the power input and/or output of the entire grid section 1 only minimally.

FIG. 3 illustrates a characteristic curve of an energy consumption or generation unit 8, 10, 11 having controllable power input and/or output as a function of the grid voltage U_{NS} present at the individual unit. The active power change ΔP is plotted, in which positive values represent an increase of the power output or a reduction of the power consumption. In addition, a range Uₙₒᵣₘ is illustrated, which comprises the normal grid voltages. A further range U_{zul.}depicts grid voltages which are still allowed which, however, already approach the grid voltage limits. The power input or output ΔP is influenced over the grid voltage ranges which are covered by U_{zul}, but not by Uₙₒᵣₘ, by changing U_{NS} with the aid of the local grid transformer 2 according to FIG. 1. Via a grid voltage U_{NS} in the partial range depicted by U₋, i.e., via a very high grid voltage level, it is thus specifically ensured that the power output of the energy generation units 8 according to FIG. 1 is reduced and the power consumption of the energy consumption units 10 is increased, or the energy storage units 11 shift from power output to power consumption. All this results in the local grid voltage in the area of the respective units dropping. In other words, despite a shift of the grid voltage level upwards, a lowering of the peaks takes place and thus a reduction of the spread of the grid voltage in the grid section 1. These measures are expedient in particular if the active power flow via the local grid transformer 2 into the grid indicates that a great deal more electric energy is generated overall in the grid section 1 than is removed there. This is a clear indication that local excessive voltage rises occur.

Conversely, in the case of an active power flow into the grid section, it may be assumed that locally, more electric energy is consumed than generated. In this case, it is ensured via a grid voltage U_{NS} in the range U₊, i.e., via a rise in the grid voltage level via the characteristic curve according to FIG. 3, that the power consumption of the energy consumption units 10 is reduced and the power output of the energy generation units 8 is increased, or the energy storage units 11 switch from power consumption to power output.

In order for the controller 13 of the local grid transformer 2 to be able to act in a targeted manner against local peaks of the grid voltage in the grid section 1, the grid voltage 17 measured at the individual controlled energy consumption or generation unit 8, 10 and 11 must be transmitted to corresponding inputs 18 of the controller 13. However, for this purpose, a simple communication structure which is also only unidirectional is sufficient, which optionally includes only the transmission of an overshooting of limit values for the grid voltage, for example, an entry into the ranges U₊ or U₋.

For the part of the branch 6 separated from the local grid transformer 2, the linear regulator 12, due to control commands 19 from a local controller 20, assumes the function of the local grid transformer, i.e., it controls the power consumption of the energy generation units 8 connected to this part of the branch 6 by raising or lowering the grid voltage level for this part of the branch 6. The local controller 20 is connected to measuring devices 21 and 22 for a power flow through the linear regulator 12 and an instantaneous value of the grid voltage in this part of the branch 6, respectively, and it comprises inputs 23 for the grid voltage 17 measured at the individual controlled energy generation units 8 in this part of the branch 6.

Many variations and modifications may be made to the various embodiments of this disclosure without departing substantially from the spirit and principles of this disclosure. All such modifications and variations are intended to be included herein within the scope of the present disclosure, as defined by the following claims.

1. A method of stabilizing the grid voltage in a grid section connected to a higher-level grid via an apparatus having a variable voltage transformation ratio, the grid section including at least one energy consumption or generation unit whose power consumption or output is controlled via a characteristic curve of the grid voltage present there, the characteristic curve raising the power consumption of the energy consumption or generation unit with a rising grid voltage or lowering the power output of the energy consumption or generation unit with a rising grid voltage, the method comprising:
changing the voltage transformation ratio in order to change a grid voltage level in the grid section, wherein changing the voltage transformation ratio, in at least one mode of the method, includes at least one of:
raising the grid voltage level in order to counteract a rise in the grid voltage at the energy consumption or generation unit; and
lowering the grid voltage level in order to counteract a drop in the grid voltage at the energy consumption or generation unit.

2. The method of claim 1, wherein the characteristic curve of each controlled energy consumption or generation unit controls active power consumption or output of the respective controlled energy consumption or generation unit.

3. The method of claim 1, wherein the characteristic curve has a dead band having an adjoining slope on both sides of the dead band within a tolerance band of the grid voltage.

4. The method of claim 1, further comprising determining the characteristic curve depending on a given grid impedance at a location of the energy consumption or generation unit.

5. The method of claim 1, further comprising:
monitoring an active power flow through the apparatus for an overshooting of an active power limit value; and
activating the at least one mode of the method when an active power flow is above the active power limit value.

6. The method of claim 1, further comprising measuring an active power flow through the apparatus at the apparatus.

7. The method of claim 6, further comprising matching a change in the voltage transformation ratio to the characteristic curves in such a way that the active power flow through the apparatus is kept within predefined active power flow limits.

8. The method of claim 6, further comprising changing the voltage transformation ratio in the at least one mode of the method as a function of the active power flow through the apparatus and an instantaneous value of the grid voltage which is measured as a measure of the grid voltage level at a point near the apparatus on its grid section side.

9. The method of claim 1, further comprising changing the voltage transformation ratio in the at least one mode of the method as a function of the grid voltage measured at the at least one energy consumption or generation unit.

10. The method of claim 1, wherein in the at least one mode of the method, the method is carried out in a cascaded manner both in the grid section and in a grid subsection including at least one additional apparatus having a variable voltage transformation ratio.

11. The method of claim 1, further comprising using a controllable local grid transformer or a linear regulator as the apparatus.

12. An apparatus having a variable voltage transformation ratio for connecting a grid section to a higher-level grid, the apparatus comprising:
a controller configured to set the voltage transformation ratio in order to set a grid voltage level in the grid section, wherein the controller, in at least one operating mode, is configured to at least one of:
raise the grid voltage level in order to counteract a rise in the grid voltage at the energy consumption or generation unit; and
lower the grid voltage level in order to counteract a drop in the grid voltage at the energy consumption or generation unit.

13. The apparatus of claim 12, further comprising one or more devices configured to detect an active power flow through the apparatus and to monitor the active power flow through the apparatus for the overshooting of an active power limit value,
wherein the controller is configured to transit into the at least one operating mode if an active power flow is above the active power limit value.

14. The apparatus of claim 12, further comprising one or more devices connected to the controller and configured to measure the active power flow through the apparatus.

15. The apparatus of claim 12, further comprising one or more devices connected to the controller and configured to measure the grid voltage level in the form of a grid voltage at a point near the apparatus on a grid section side of the apparatus.

16. The apparatus of claim 12, wherein the controller includes inputs for local grid voltages measured at individual energy consumption or generation units in the grid section.

17. The apparatus of claim 12, being a local grid transformer.

18. The apparatus of claim 12, being a linear regulator.
